(19) United States
(12) Patent Application Publication
(10) Pub. No.: US 2012/0259797 A1
(43) Pub. Date: Oct. 11, 2012

(54) METHOD AND APPARATUS FOR INVESTMENT STRATEGIES DERIVED FROM VARIOUS RESEARCH METHODOLOGIES AND EXTRACTIONS

(76) Inventors: Michelle Sarkany, Fresh Meadows, NY (US); Thomas Sarkany, Fresh Meadows, NY (US)

(21) Appl. No.: 13/441,082

(22) Filed: Apr. 6, 2012

Related U.S. Application Data
(60) Provisional application No. 61/472,280, filed on Apr. 6, 2011.
(60) Provisional application No. 61/472,295, filed on Apr. 6, 2011.

(51) Int. Cl. G06Q 40/06

(52) U.S. Cl. 705/36 R

(57) ABSTRACT

The present invention provides a computer based apparatus and methodology for generating investment strategies for individuals by using a variety of research and screening methodologies to extract investment tools and data from publicly available data basis, while also utilizing computerized search skills, this business model looks to improve on investment methods currently offered by brokers and registered investment advisors. Several modules are provided that perform certain analyses based on information from the investor as well as other sources. Each module can be used as a stand-alone unit or can share information and prepare aggregate reports to the investor.

### RELATED APPLICATIONS

This application claims benefit to U.S. Provisional Patent Applications Ser. No. 61/472,280 and 61/472,295 filed on Apr. 6, 2011 and incorporated herein by reference in their entirety.

### BACKGROUND OF THE INVENTION

a. Field of Invention

This invention pertains to a computer based apparatus for analyzing investment portfolios of individuals and generating information related to optimum asset allocations for the same.

b. Description of the Prior Art

Some individuals have retirement plans provided by their employer. These retirement plans have professional managers to handle how the assets from a common retirement fund for various plans are being allocated. However, many other individuals do not have the benefit of such professional financial managers and must make their own decisions on how to handle their savings and allocate them. For these individuals, financial information (both paid and free) is available from many different sources and organizations—in fact there is so much information available that an individual has to spend many hours of research at regular intervals to determine what is best for his or her situation.

Thus, there is a need for an apparatus and methodology that provides an individual a customized investment strategy that has been optimized for his or her needs.

### SUMMARY OF THE INVENTION

The present invention provides a computer based apparatus and methodology for generating investment strategies for individuals by using a variety of research and screening methodologies to extract investment tools and data from publicly available data basis, while also utilizing computerized search skills, this business model looks to improve on investment methods currently offered by brokers and registered investment advisors. Several modules are provided that perform certain analyses based on information from the investor as well as other sources. Each module can be used as a stand-alone unit or can share information and prepare aggregate reports to the investor.

For example, the apparatus may contain five primary modules, Asset Allocation, Portfolio Analysis, Popular Securities, Valuation Discovery and the fifth combined module Construction of Portfolio, which combines the said four primary modules.

Asset Allocation Module: Utilizing Consensus of Publicly Disclosed Asset Allocations of Mutual Funds or Exchange Traded Funds to Allocate Assets or to Verify Existing Asset Allocation.

Portfolio Analysis Module: Analysis of Customer Investment Portfolio to Determine Whether the Portfolio is Appropriate for this Customer.

Popular Securities Module: Internet Website System Presenting Consolidated View of Investment Opportunities Published in Major Media Sources.

Valuation Discovery Module: Utilizing Publicly Disclosed Events and Corporate Actions to Discover Valuation Events for Publicly Traded Securities and Publicly Traded Portfolios.

Construction of Portfolio Module: Constructing customer's investment portfolio based on customer's personalized asset allocation, and based on most popular securities representing required asset classes, and based on the customer's existing portfolio and incorporating valuation events as performance enhancement.

### BRIEF DESCRIPTION OF THE DRAWINGS

FIG. 1 shows a block diagram of a computer based apparatus for performing the subject invention including several modules;

FIG. 1A(1)-(2) provides a flow chart for the ASSET ALLOCATION MODULE of FIG. 1;

FIG. 1B—provides a flow chart for the PORTFOLIO ANALYSIS MODEL of FIG. 1;

FIG. 1C—provides a flow chart for the POPULAR SECURITIES MODULE of FIG. 1;

FIG. 1D(1)-(3) flow chart for F-1 VALUATION DISCOVERY MODULE

FIG. 2A-2B shows the CONSTRUCTION OF PORTFOLIO MODELS

FIG. 3—Exhibit A.01. Hypothetical Example of Asset Allocation in Several Target Maturity Mutual Funds

FIG. 4 Exhibit A.02. Hypothetical Consensus Weights 2034 derived from 2030 and 2035

FIG. 5 Exhibit A.03 High Level Computer System Configuration

FIG. 6—Exhibit B.01: Customer Submitted Stock Portfolio as Presented by the Website after Filtering

FIG. 7, 7A—Exhibit B.03: Customer's Current and Recommended Stock Portfolios

FIG. 8—Exhibit B.04 Suggested additions to the customer current stock portfolio

FIG. 9—Exhibit B.05. Schematic Implementation of the Portfolio Analysis Module

FIG. 10—Exhibit B.06 Schematic Implementation of the Portfolio Analysis Engine

FIG. 11—Exhibit C.01. Screenshot: Digest of the exchange traded portfolios:—Best Exchange Traded Portfolios in the Press

FIG. 12—, 12(A), 12(B) Exhibit C.02. Screenshot: Digest of the common stocks:—Best Stocks in the Press

FIG. 13—Exhibit C.03. Screenshot: Digest of the mutual funds:—Best Mutual Funds in the Press

FIG. 14—Exhibit C.04. Flow Chart of Automatic Digest

FIG. 15—Exhibit D.01. Scheme of System Module

FIG. 16—Exhibit D.02 Back-test the historical performance of the constructed investment portfolio versus benchmarks

FIG. 17—Exhibit D.03 Output: Back Test of the Customer's Constructed Portfolio

FIG. 18 Exhibit E.01 A hypothetical customer inquiry

FIG. 19, 19A, 19B, 19C Exhibit E 0.02 Output of customer's query from Exhibit E.01

### DETAILED DESCRIPTION OF THE INVENTION

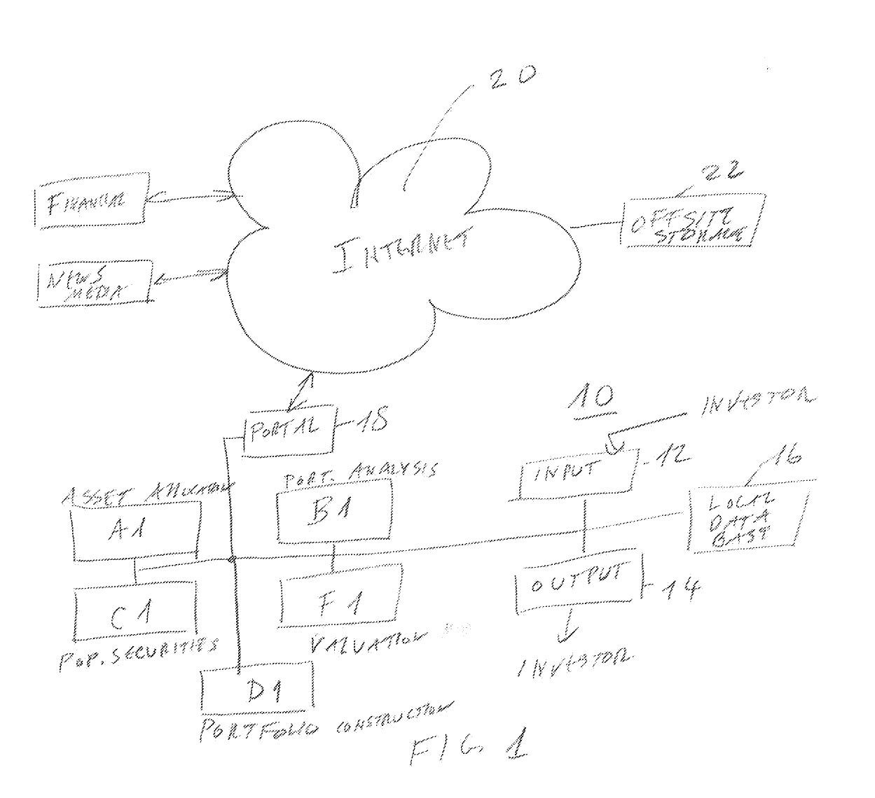

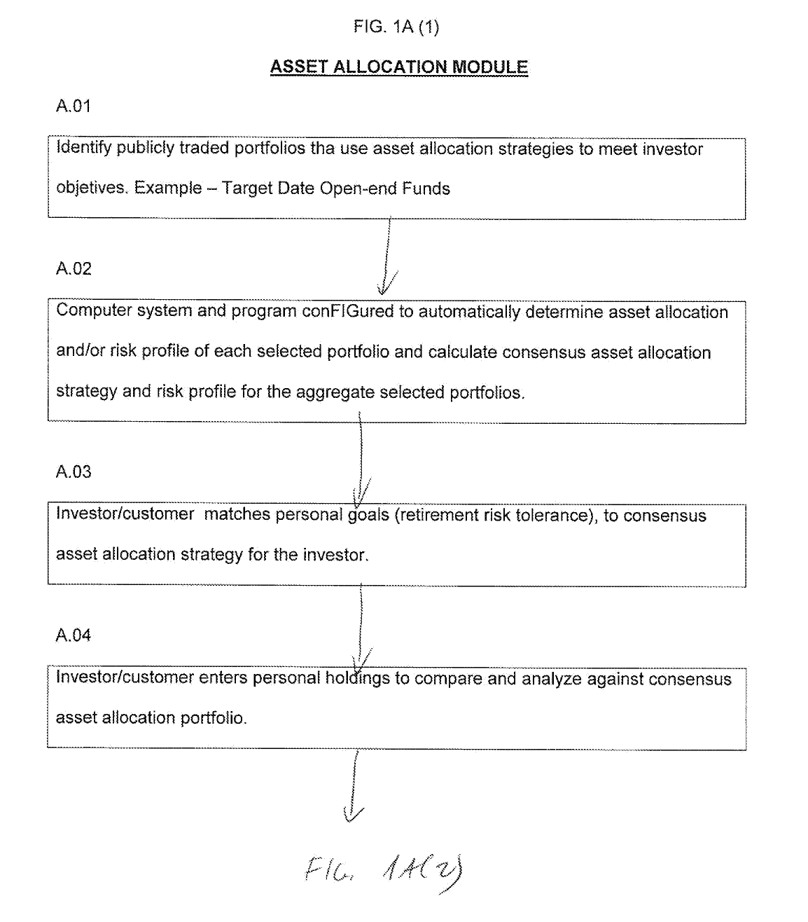

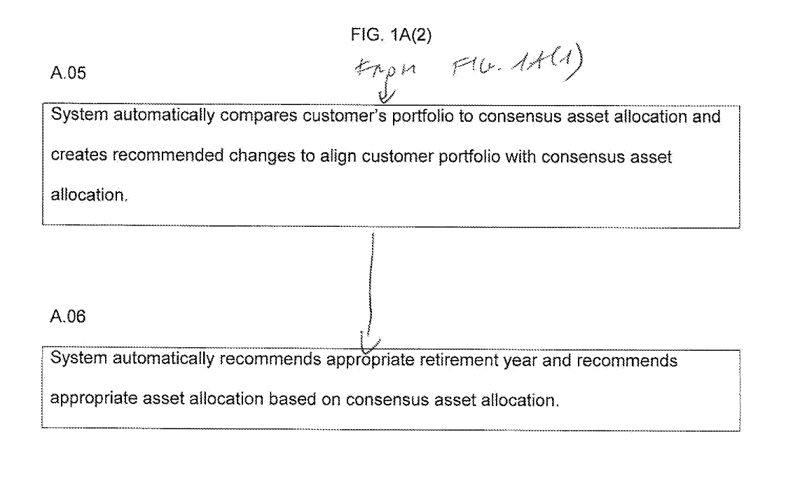

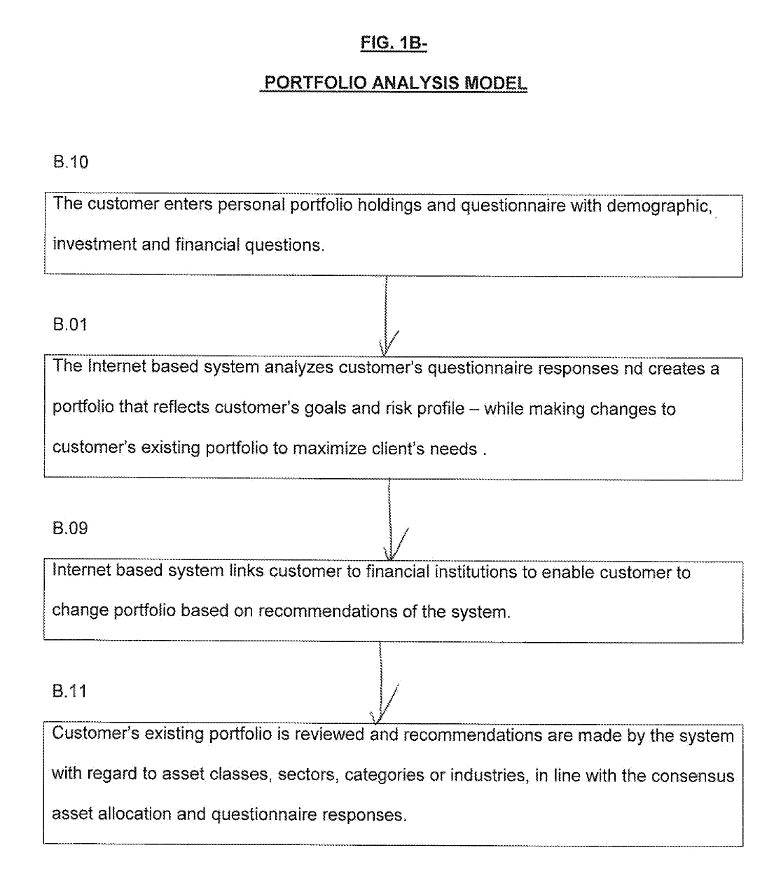

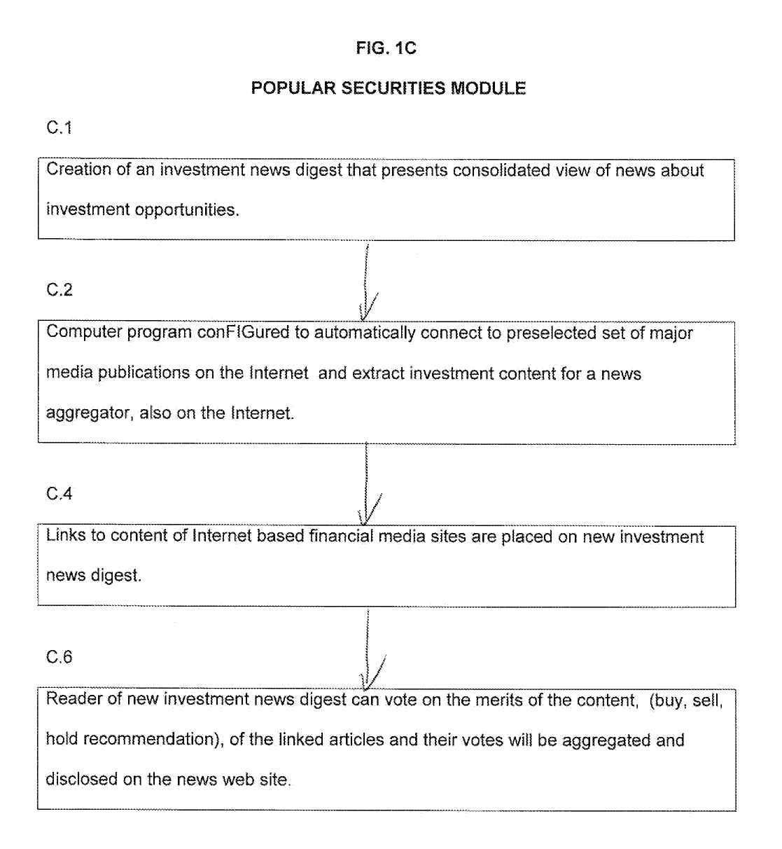

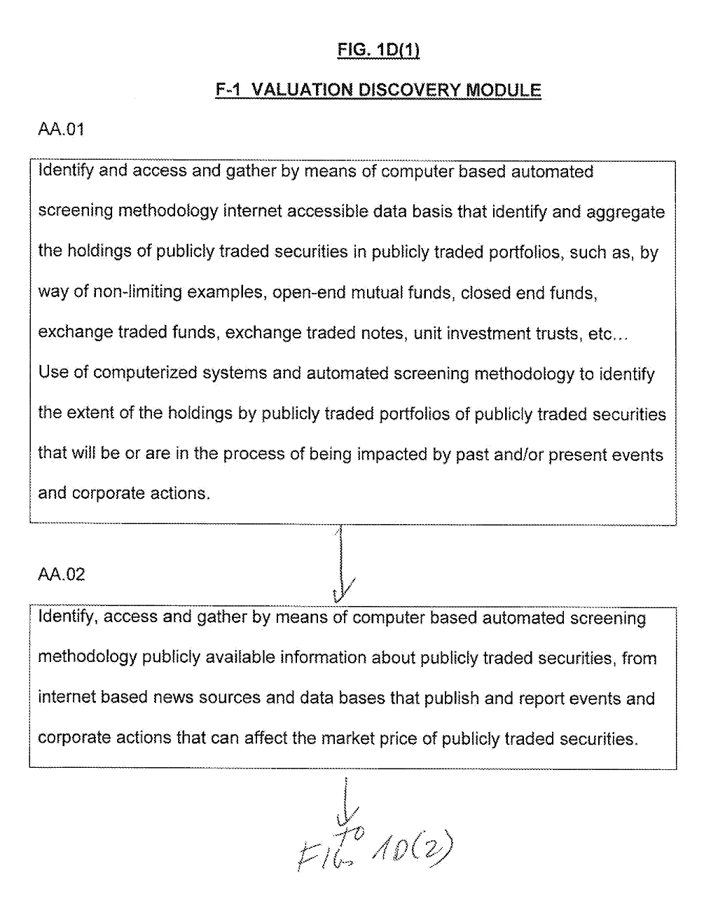

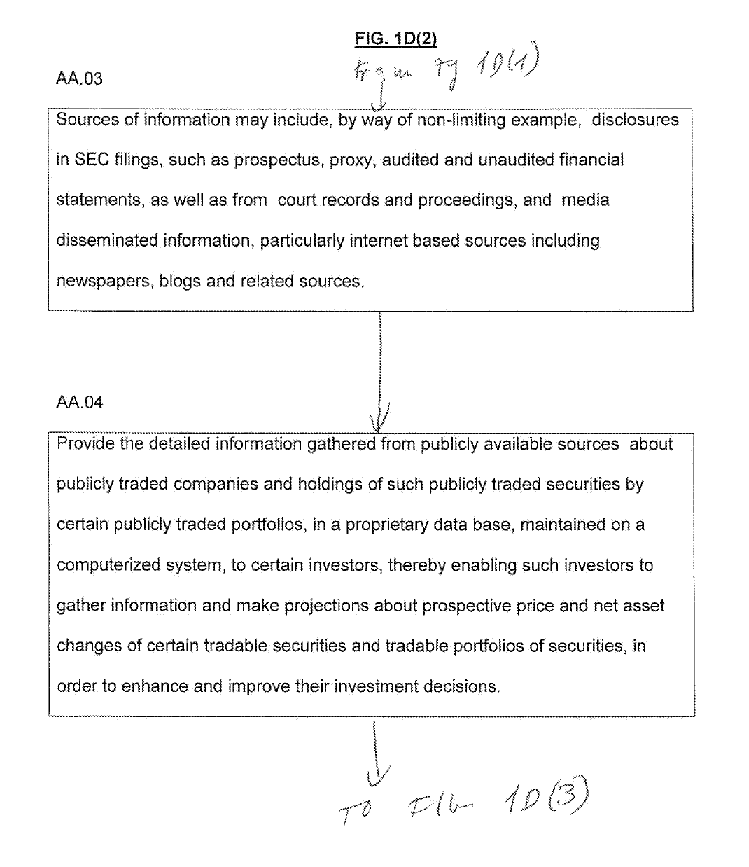

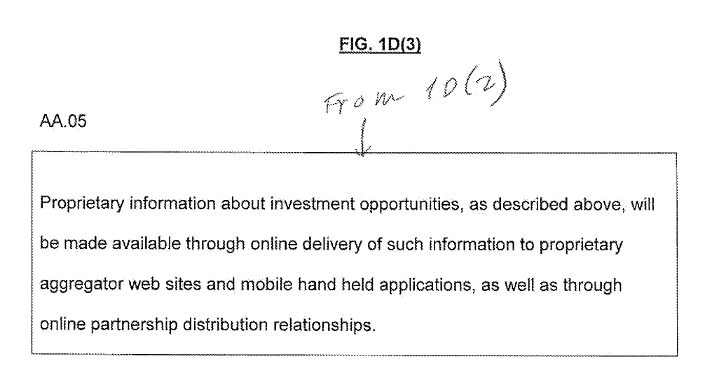

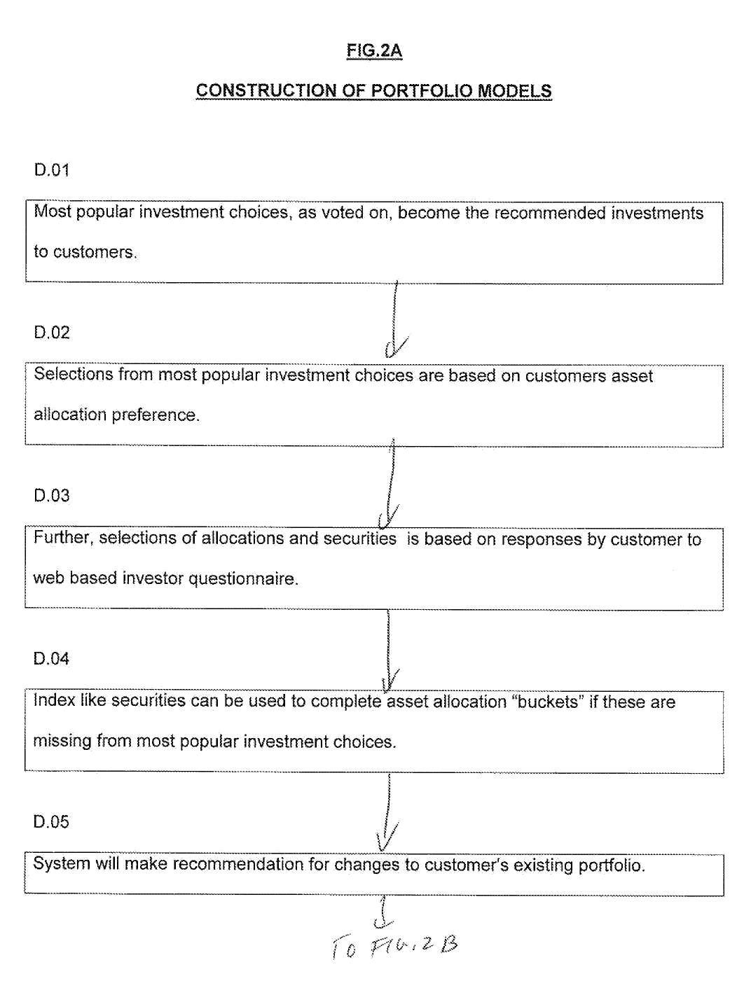

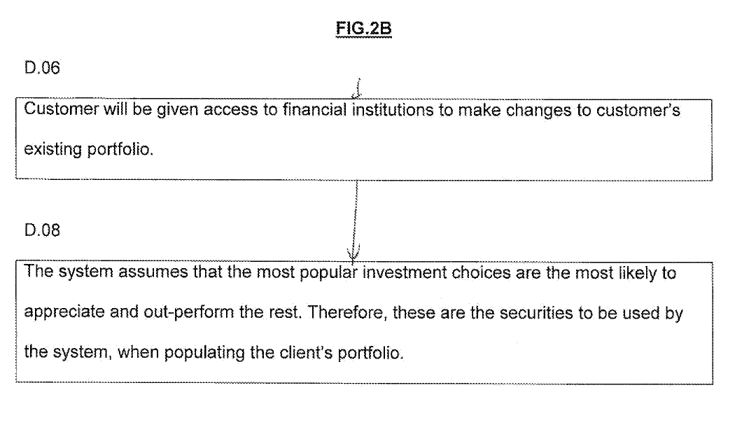

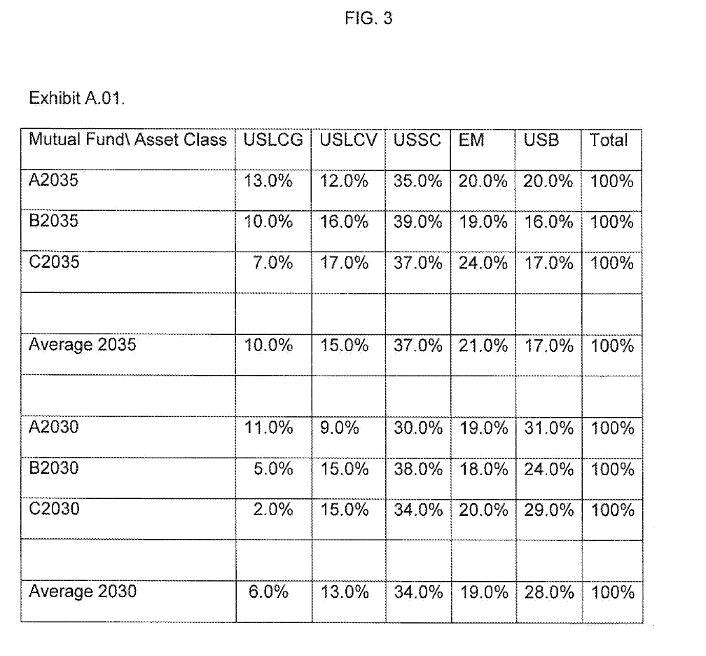

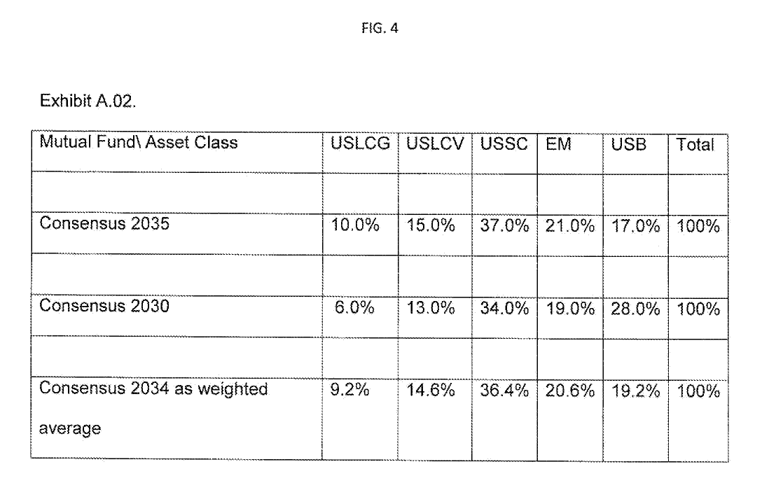

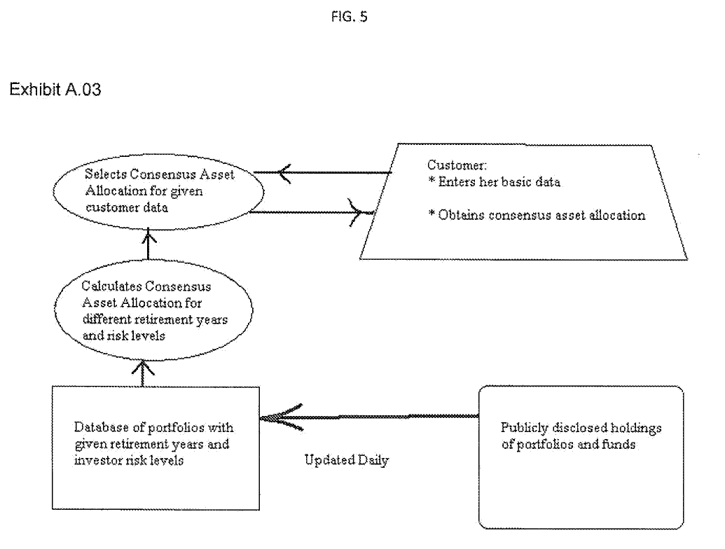

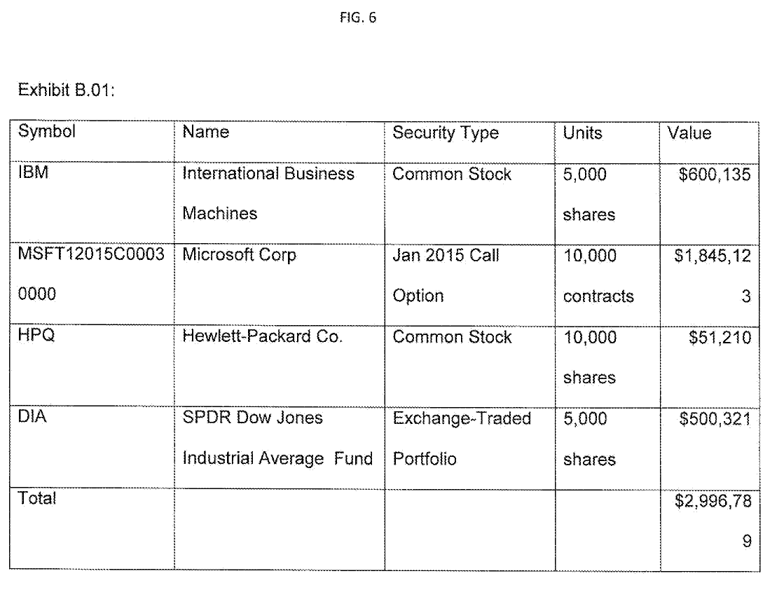

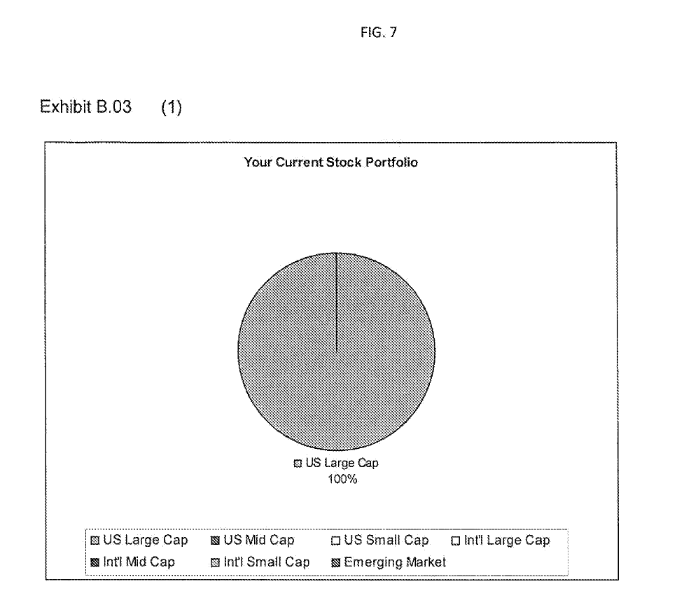

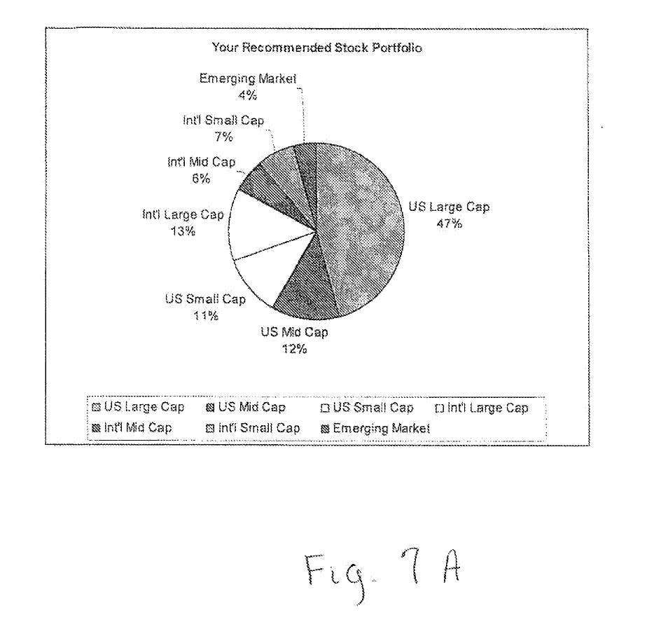

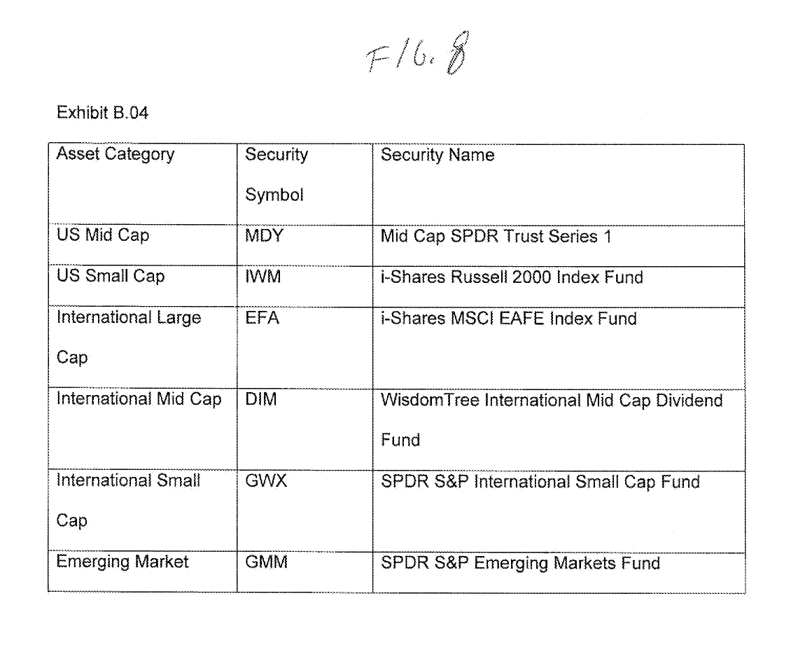

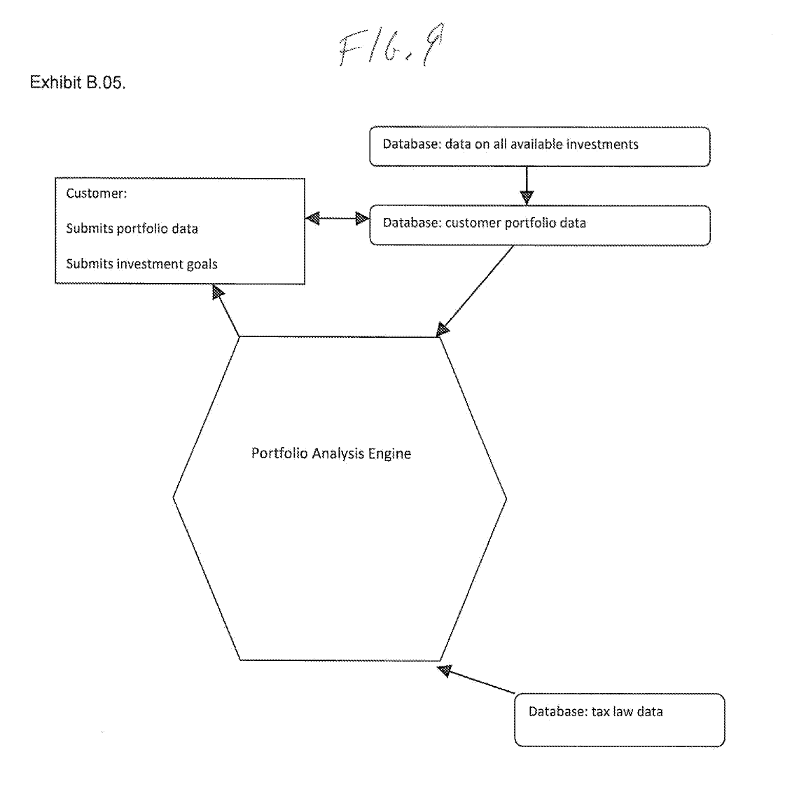

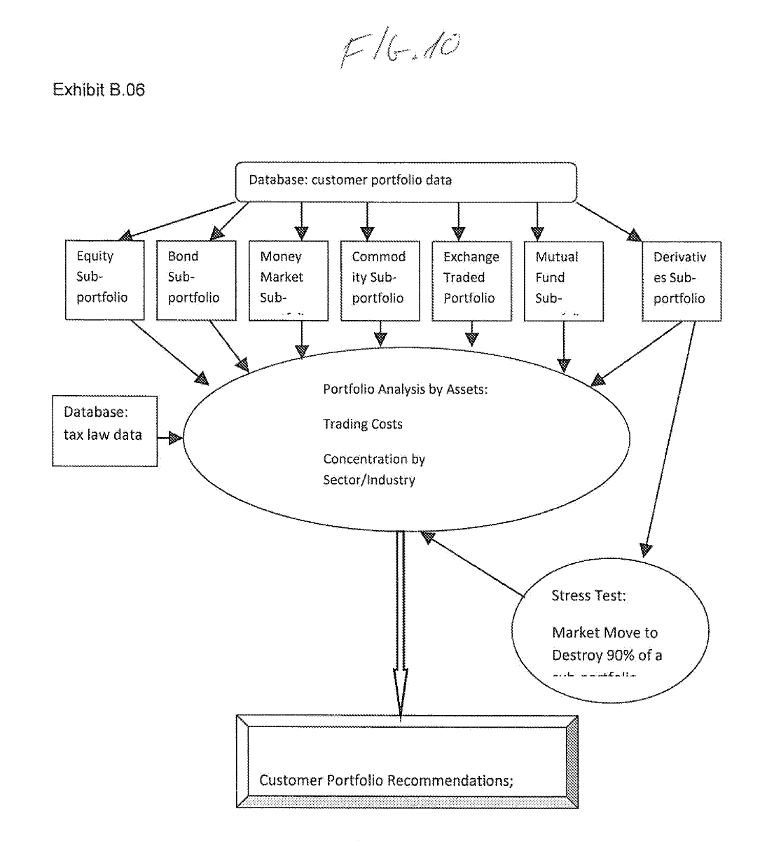

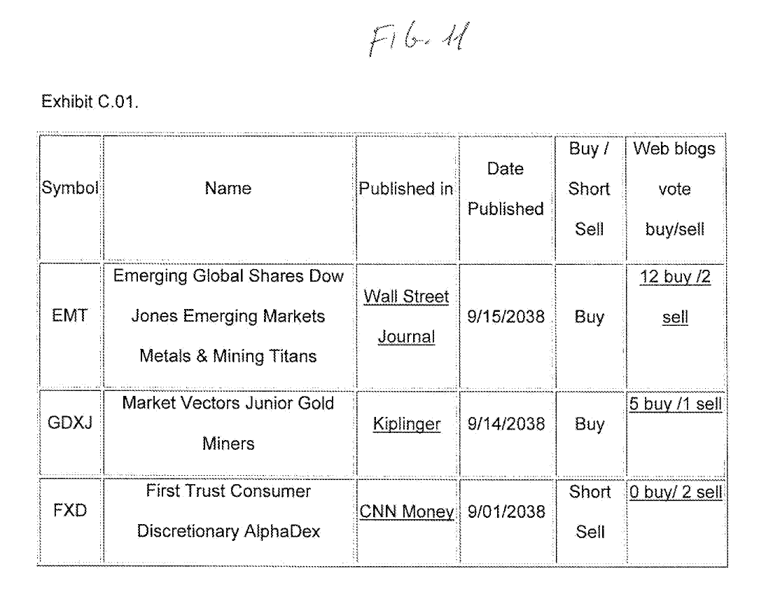

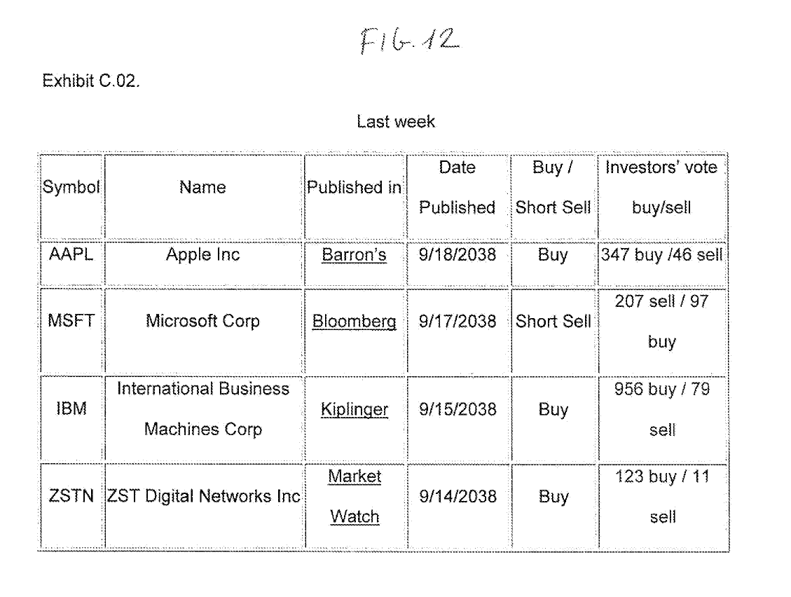

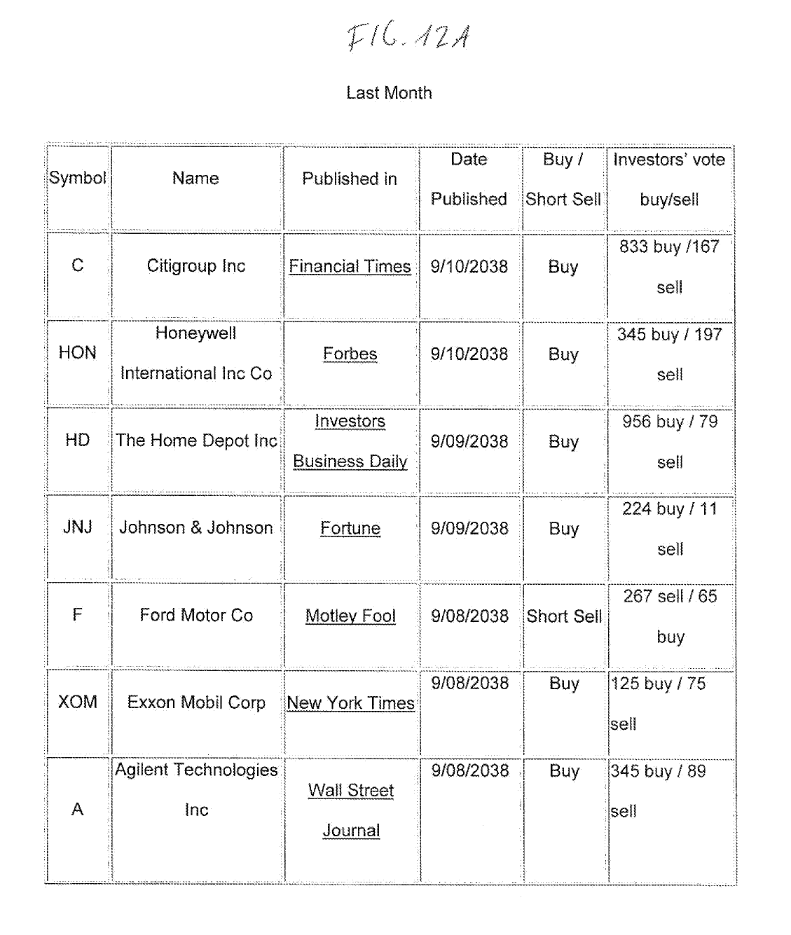

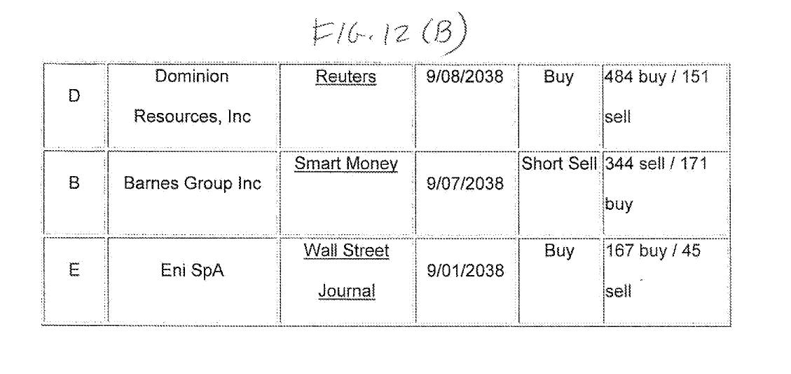

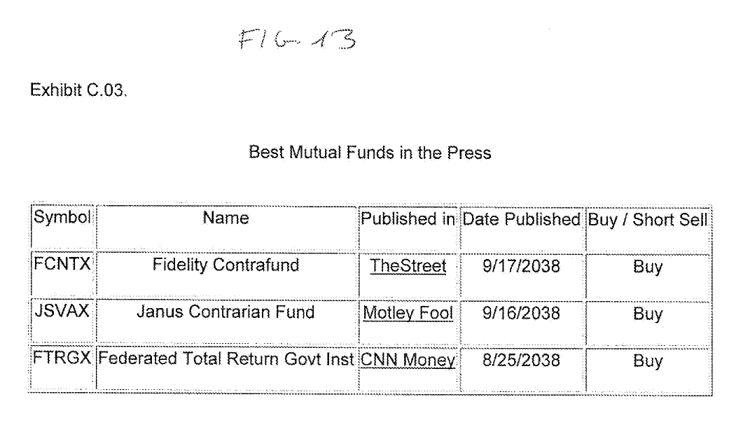

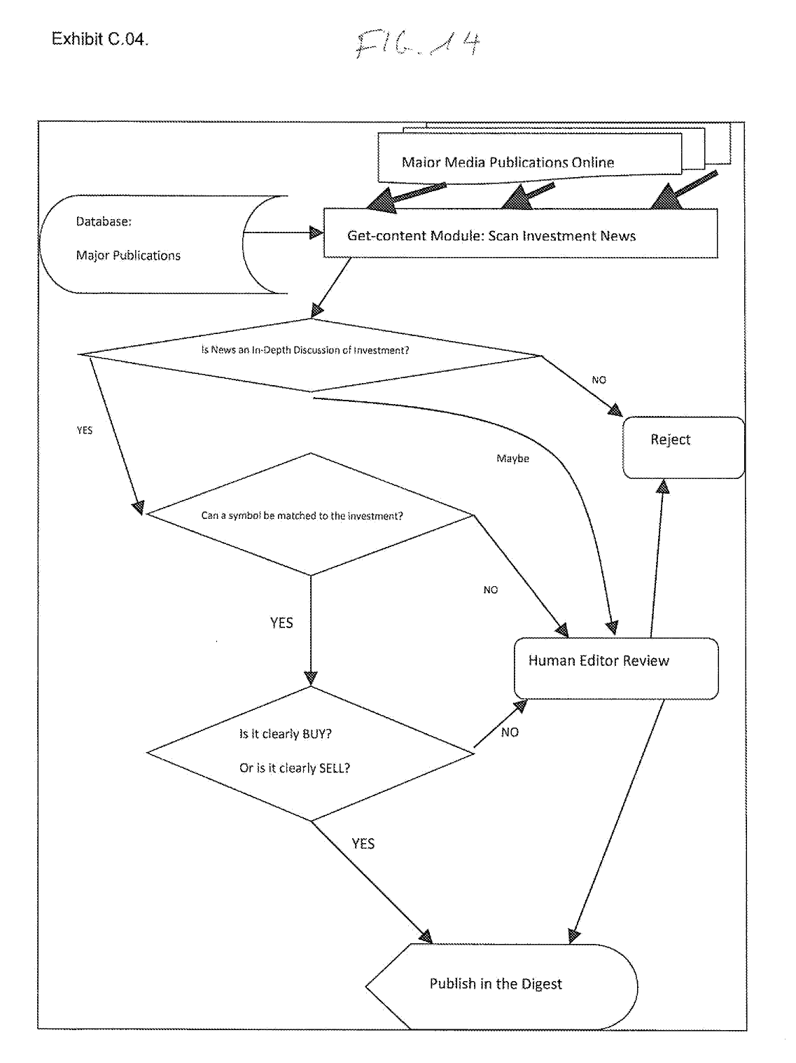

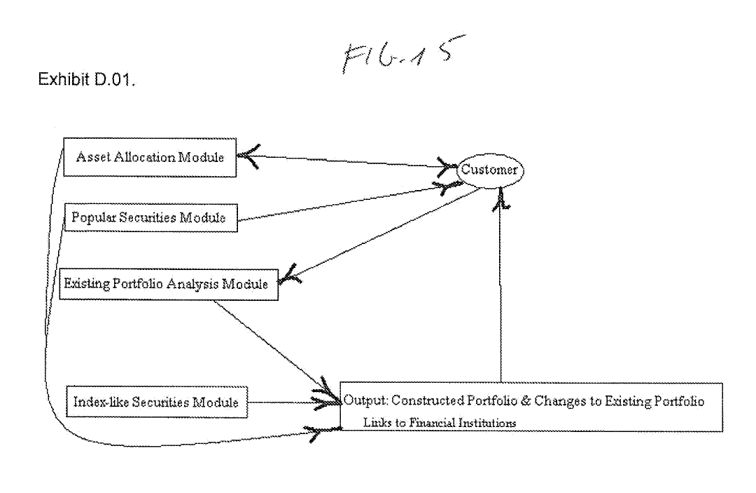

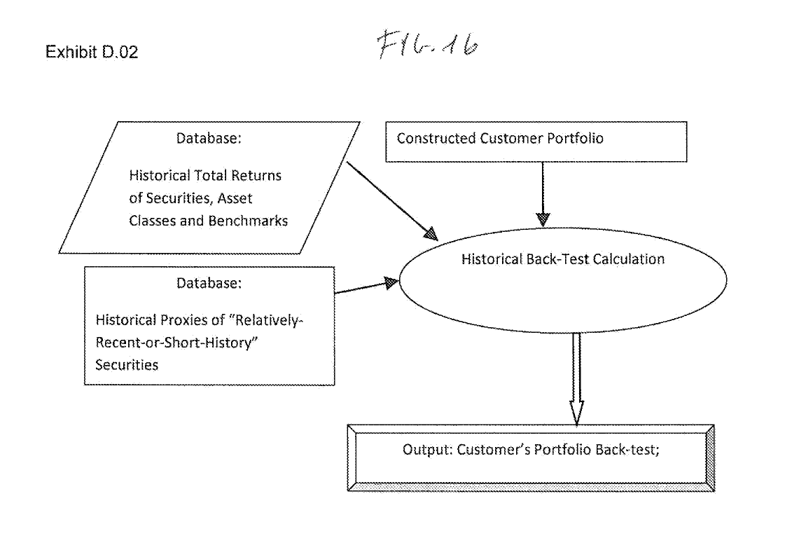

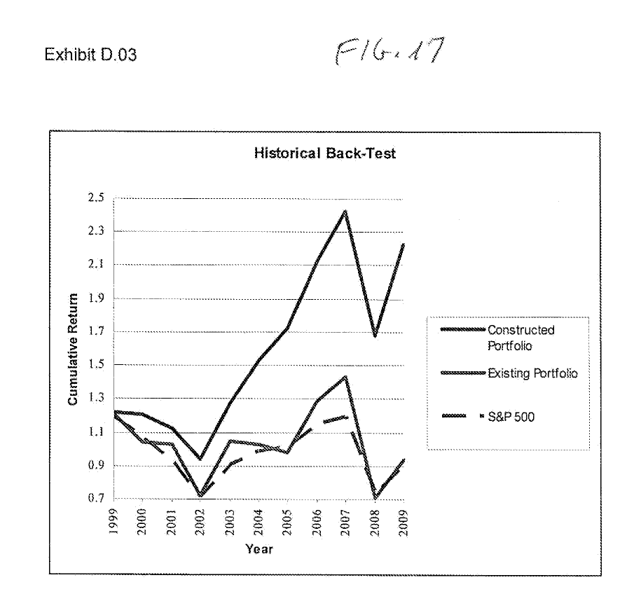

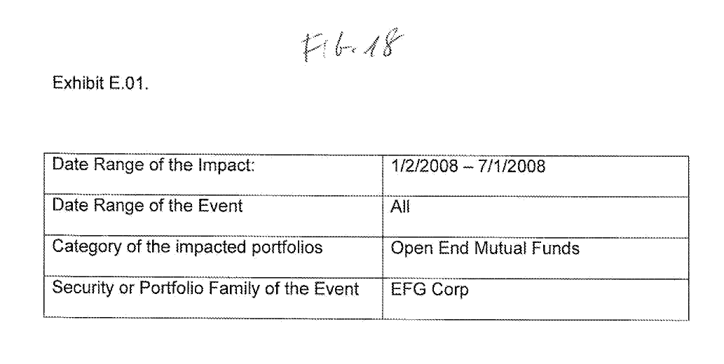

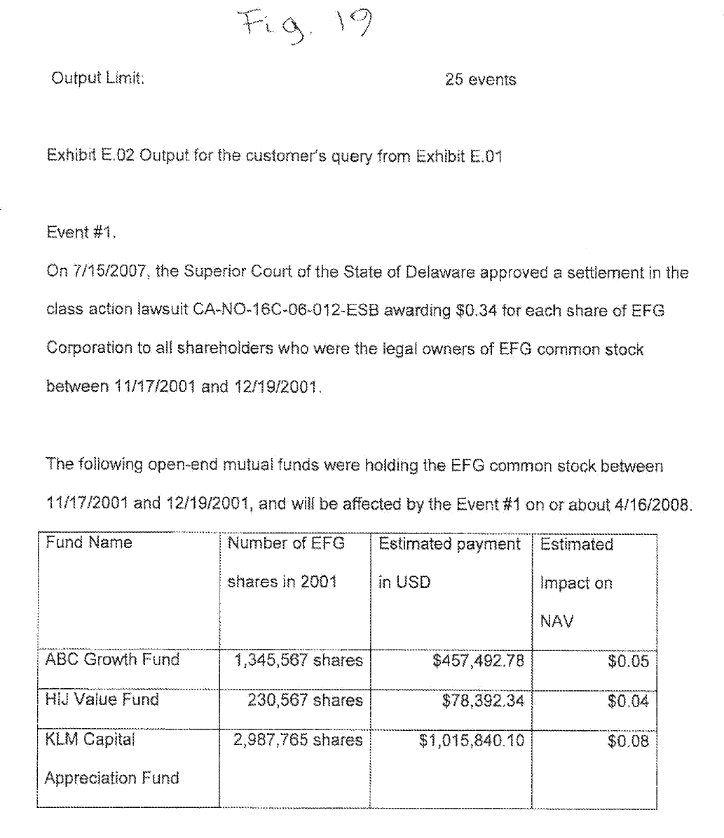

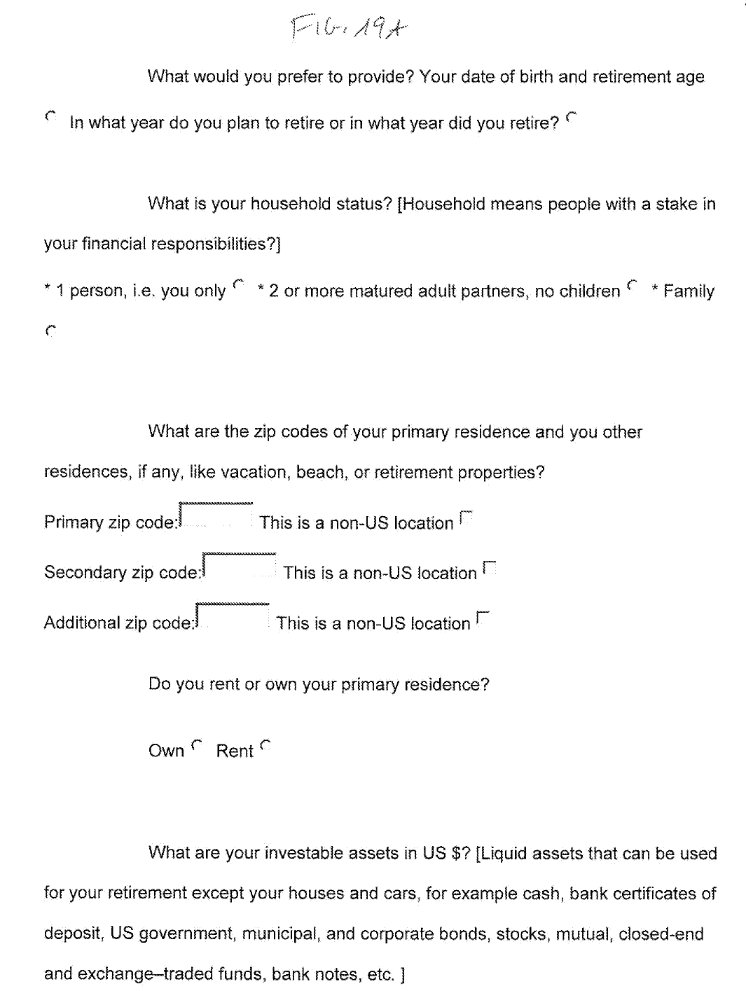

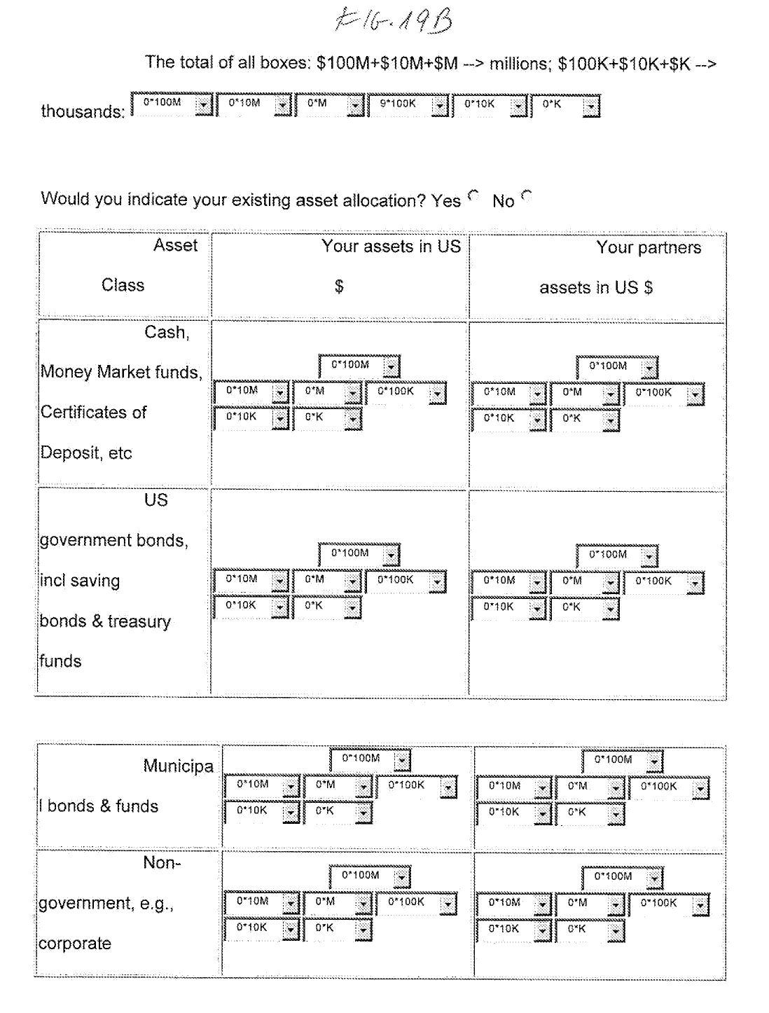

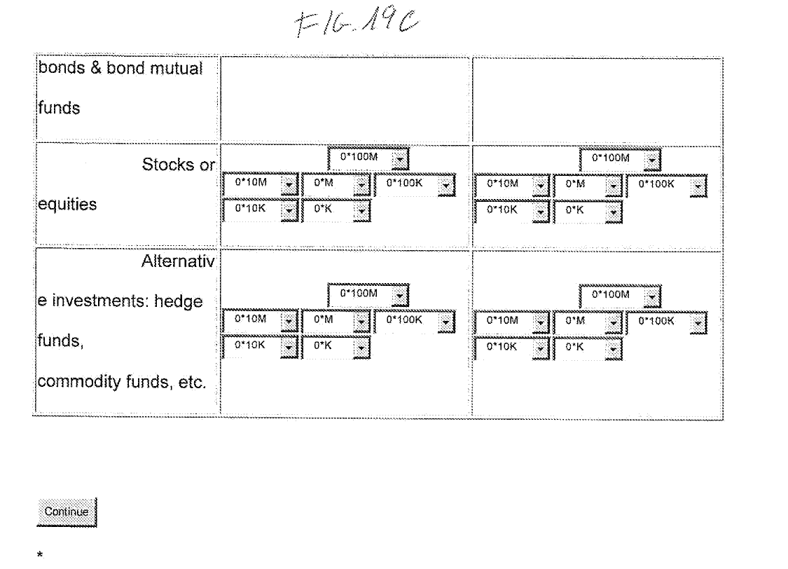

FIG. 1 shows a block diagram of the apparatus constructed in accordance with this invention. The apparatus is computer based and it includes four softwater implemented modules: an asset allocation module A1, a portfolio analysis module B1, a popular securities module C1, a valuation module F1 and a portfolio construction module D1. The apparatus 10 further includes an input 12 through an investor inputs various information, an output 14 through which the investor receives instructions and information and a local database 16 on which investor information is stored securely. In addition, the apparatus can obtain information from various external sources, such as financial sources 17 and news media 19 through a portal 18 connected to the Internet 20. Some personal information of the investor may also be stored on a secure offsite database 22.

The operation of the various modules is now described in conjunction with the Figures.

Asset Allocation Module A1: Internet-based business system automatically determining consensus asset allocation from publicly available allocations of mutual funds or exchange-traded portfolios for different retirement years or for different risk profiles and recommending asset allocation for a customer based on the said customer's retirement year, risk profile, and other self-entered demographical and financial information. The system automatically generates customized asset allocation and suggests changes to an existing asset allocation based on self-entered customer demographical and financial data.

Portfolio Analysis Module B1: Internet-based business system analyses a customer current portfolio versus investment goals of the said customer. The system determines the goals of the said customer via a web-based questionnaire. The system then suggests changes to the customer current portfolio either to better align the said portfolio with the said customer's investment goals, or to improve performance and diversification of the said customer's current portfolio.

Popular Securities Module C1: Internet-based system, method, and apparatus to automatically or semi-automatically present consolidated view of investment opportunities published in various media sources.

The said system presents links and references to only in-depth, fundamental edited discussions of investment opportunities in popular and trusted media sources, and the said system filters out and does not show routine announcements about investment opportunities.

Unlike existing methods and systems, the said system does not limit references to media discussions of only investment opportunities selected by a customer, nor is the said system cluttering customers with all investment opportunities mentioned in all media sources. Instead, the said system gives its customers a quick consolidated view of the investment opportunities that were recently discussed in-depth and fundamentally in the most popular and creditworthy media sources. Therefore, the customers of the said system can make their decision whether to follow the advice of the said referenced media sources on a particular investment opportunity, or to take a different action on the said opportunity.

Valuation Discovery Module F1 is a database, system, and method to report events and corporate actions in traded securities affecting pricing of publicly traded portfolios or funds which hold currently or held in the past the said event-affected securities. The system also reports events in publicly traded portfolios or funds that can affect prices of one or more securities either composing the said event-affected publicly traded portfolios or funds or being included into the event-affected publicly traded portfolios or funds in the future.

Construction of Portfolio Module: D1 Internet-based business system automatically constructing investment portfolio based on customer's personalized asset allocation where securities representing different asset classes and categories are so-called popular securities. The said popular securities are selected, for example, based on media publications. The said customer can make changes to the said constructed portfolio.

The said system takes into account the existing customer's investment portfolio, and suggests changes to the said existing portfolio to better align the said customer's existing portfolio with the investment portfolio constructed for the said customer. Furthermore, the said system performs a back-test of the performance of the said constructed investment portfolio upon request of the said customer.

Asset Allocation Module A1: Important Features and operation

The Asset Allocation Module invention has the following important features and operation

A.01. A computer based system to determine consensus asset allocation from publicly traded portfolios or portfolios publicly disclosing their holdings. The said portfolios publicly disclosing their holdings can be, by the way of a non-limiting example, open-end mutual funds, closed end funds, exchange traded funds, exchange traded notes, publicly traded investment management companies, unit investment trusts (UIT), investment clubs publicly disclosing their holdings, and similar securities. The said portfolios are designed, according to their prospectus or marketing materials, for a certain retirement year of their investors, or for certain risk profile of their investors. By the way of a non-limiting example, the said design for a specific retirement year can be a target maturity fund, or the said design for a specific risk profile can be a balanced fund for conservative, moderate, or risk-aggressive investors.

A.02. The system of feature A.01, wherein a computer system is Internet based and the said computer program is further configured to automatically obtain publicly disclosed holdings of predetermined portfolios, and to calculate a consensus asset allocation for a given retirement year or a given risk profile, or both retirement year and risk profile, as an average of all the portfolios designed for a given retirement year and a given risk profile.

A.03. The system of feature A.01, wherein an Internet based computer system allows a customer to self-enter his or her basic demographical and financial information to determine the said customer's retirement year and an approximate risk level, and recommend to the said customer a consensus asset allocation matching the said customer's retirement year and the said customer level of risk. The customer is presented a very transparent description of how the consensus asset allocation was obtained and what set of portfolios with publicly disclosed holdings and publicly stated retirement goals were used to obtain a consensus asset allocation for the said customer

A.04. The system of feature A.01, wherein an Internet based computer system allows a customer to self-enter the investments held in his or her portfolio and his or her investment goals, and a computer program is further configured to automatically analyze the customer portfolio, and to compare the said customer portfolio with a consensus asset allocation derived from portfolios publicly disclosing their holdings and targeting investment goals similar to the said customer.

A.05. The system of features A.01, A.03, and A.04, wherein an Internet based computer system is further configured to automatically display in the customer's web browser the changes recommended to the said customer's investment portfolio to bring the said customer's investment portfolio in line with consensus asset allocation for the said customer's self-entered retirement year and risk level.

A.06. The system of features A.01 and A.03, wherein an Internet based computer system is further configured to adjust the customer retirement year based on the said customer's risk level, and to recommend the consensus asset allocation for the said customer based on the adjusted retirement year and not on the self-entered retirement year, and wherein the web page clearly explains the reason for adjusting the retirement year and the adjustment procedure to the said customer

Portfolio Analysis Module: Important Features and operation

The Portfolio Analysis Module invention has the following important features

B.01. An internet-based system to determine customer current investment portfolio holdings, to obtain a broadly defined investment goals, objectives, and style of the said customer, and to analyze whether the said investment portfolio is appropriate for the said customer's investment goals, objectives, and style.

B.02. The system of feature B.01, wherein the said internet-based system is further configured to recommend changes to the said customer current investment portfolio to reduce portfolio volatility and limit losses.

B.03. The system of feature B.01, wherein the said internet-based system is further configured to recommend changes to the said customer current investment portfolio to increase portfolio expected returns without increasing volatility and losses.

B.04. The system of feature B.01, wherein the said internet-based system is further configured to recommend changes to the said customer current investment portfolio to reduce portfolio trading costs.

B.05. The system of feature B.01, wherein the said internet-based system is further configured to recommend changes to the said customer current investment portfolio to increase portfolio diversification and to either improve portfolio expected return or to reduce portfolio expected losses.

B.06. The system of feature B.01, wherein the said internet-based system is further configured to recommend changes to the said customer current investment portfolio to improve portfolio tax efficiency and facilitate customer estate planning.

B.07. The system of feature B.01, wherein the said internet-based system is further configured to recommend changes to the said customer current investment portfolio to make the portfolio compliant with the said customer's beliefs and personal values.

B.08. The system of feature B.01, wherein the said internet-based system is further configured to assign a numerical score to the said customer portfolio. The said numerical score indicates how appropriate the said investment portfolio is for the said customer investment goals, objectives, and style.

B.09. The system combining one or more of the features B.02, B.03, B.04, B.05, B.06, B.07, and B.08, wherein the said internet-based system is further configured to offer the said customer links to financial institutions to implement the recommended changes to the said customer current investment portfolio.

B.10. The system of feature B.01, wherein the said internet-based system is further configured to determine the investment goals, objectives, and style, of the said customer using a web-based questionnaire with basic demographic, investment, and financial questions.

B.11. The system of features B.02, B.03, B.04, B.05, B.06, and B.07, wherein the said internet-based system is further configured to suggest additions to the said customer existing investment portfolio whenever one or more of specific asset classes, categories, sectors, or industries are missing or are underrepresented in the said customer existing investment portfolio. The said additions are selected as one or more “index-like” securities broadly replicating the said specific asset classes, categories, sectors, or industries.

Popular Securities Module C1: Important Features and operation

C.1. A system, method, and apparatus to present consolidated view of news about investment opportunities, where each news item is linked to and is based on a fundamental discussion of the said investment opportunity. The said consolidated view of news items is also called an investment news digest. The said investment news digest contains the name of each investment opportunity, the trade direction, the source, i.e. the media publication with the full news item, and other information. By the way of non-limiting example, the said trade direction can be either buy, or sell, or short-sell, or hold.

C.2. The system of feature C.1, wherein a computer program is configured to automatically connect via Internet to a pre-selected set of popular media publications, and to download briefs of the news items discussing investment opportunities to a temporary database, so the publication of the said news digest can be partially automated.

C.3. The system of features C.1 and C.2, wherein the said computer program is further configured to automatically filter news items with fundamental in-depth discussions of investment opportunities separating the said news items of interest to customers from the news items with routine announcements about investment opportunities.

C.4. The system of features C.1, C.2, and C.3, wherein the said computer program is further configured to automatically publish links to some or all of the said filtered news items with fundamental in-depth discussions of investment opportunities to the said news digest.

C.5. The system of features C.1, C.2, and C.3, wherein the said computer program is further configured to automatically present the said filtered news items to a human editor for a review and to give the said human editor an option to approve or to reject the said filtered news items for the said news digest.

C.6. The system of feature C.1, wherein the said news digest is presented on an Internet website, and the said Internet website is further configured to allow the customer to vote whether they support buy or sell each security, and the aggregated result of the said customer vote is presented on the said website for the customers. The said customers voting to buy or sell each security may be from general investing public, or the said voting customers may be limited to some experts in securities. The said experts in securities, by the way of a non-limiting example, can be investment professionals, or financial advisers, or registered investment advisers, or certified financial advisers, or certified investment advisers, or institutional investors.

C.7. The system of features C.1 and C.2, wherein the said computer program is further configured to search the Internet for all media sources in addition to pre-selected popular media publications, and present an aggregated count in the said digest of how many Internet-based publications and customers reviewed each security included in the digest.

Valuation Discovery Module F1; Important Features and operation F.01. A computer based system to determine events affecting prices of publicly traded portfolios or single securities. The said publicly traded portfolios can be, by the way of a non-limiting example, open-end mutual funds, closed end funds, exchange traded funds, exchange traded notes, publicly traded investment management companies, unit investment trusts (UIT), investment clubs publicly disclosing their holdings, and similar portfolios.

F.02 The system of feature F.01, wherein the said computer program is further configured to automatically obtain publicly disclosed current and historical holdings of predetermined portfolios and to store the said holdings in a relational database for processing.

F.03 The system of feature F.01, wherein the said computer program is further configured to automatically obtain publicly disclosed events affecting current, future, or historical owners of investment vehicles and store them in a relational database for processing. The said investment vehicles can be, by the way of a non-limiting example, listed stocks of publicly traded companies, bonds, notes, commercial papers, or any other security which can be held by a publicly traded portfolio.

F.04 The system of feature F.01, wherein the said computer program is further configured to automatically obtain publicly disclosed events affecting publicly traded portfolios, or sponsors of publicly traded portfolios. The said sponsor of publicly traded portfolios can be, by the way of a non-limiting example, a financial company directly or indirectly controlling families of mutual funds.

F.05 The system of features F.01, F.02, F.03, and F.04, wherein an Internet based computer system allows a customer to enter his or her criteria selecting events or publicly traded portfolios affected by the said events or causing further effects affecting securities prices. The said Internet based system displays events and estimated effects on the prices based on customer-entered criteria.

Construction of Portfolio Module D1: Important features and operation

The Construction of Portfolio Module invention has the following important features.

D.01. An Internet-based system to construct a customer investment portfolio from the securities representing the so called most popular investment opportunities. By the way of a non-limiting example, the said most popular investment opportunities can be selected as the securities discussed in the popular trusted media sources.

D.02. The system of feature D.01, wherein the said Internet-based system is further configured to construct the said customer investment portfolio based on the customer's personalized asset allocation.

D.03. The system of feature D.02, wherein the said Internet-based system is further configured to determine the said personalized asset allocation of the said customer using a web-based questionnaire with basic demographic, investment, and financial questions.

D.04. The system of features D.01 and D.02, wherein the said Internet-based system is further configured to construct the said customer investment portfolio with the “non-popular” but index-like securities broadly replicating a specific asset class or category whenever there are no popular securities, as defined by the said system, in the said specific asset class or category.

D.05. The system of features D.01 and D.02, wherein the said Internet-based system is further configured to compare the said constructed customer investment portfolio with the existing customer's investment portfolio, and suggests changes to the said existing portfolio.

D.06. The system of feature D.05, wherein the said Internet-based system is further configured to provide customer with the links to financial institutions to implement the said suggested changes in the existing customer's investment portfolio.

D.07. The system of feature D.01, wherein the said most popular investment opportunities are selected as the securities with the largest trading parameters. By the way of a non-limiting example, the said trade parameters can be either the average daily trading volume, or the total assets invested in a security, or market capitalization available for trading, or the average ratio of mid price to bid-ask spread, etc.

D.08. The system of feature D.01, wherein the said most popular investment opportunities are selected as the securities rated by consensus of trusted investment publications to have the highest appreciation potential.

D.09. The system of feature D.01, wherein the said Internet-based system is further configured to allow the said customer to make changes to the said constructed portfolio.

D.10. The system of feature D.01, wherein the said Internet-based system is further configured to allow the said customer to back-test the performance of the said constructed investment portfolio for a specified number of years.

Construction of Portfolio Module: US Patent References

Asset Allocation Module: Background Art

There is extensive literature describing complex algorithms and methods to determine asset allocation for a customer. Several such books are given as examples in other references. US patent documents detail simulation of asset allocation in a customer portfolio, and employ internet for portfolio management.

Nevertheless, to the best of authors' knowledge, there is neither apparatus, nor method, nor device utilizing publicly available asset allocations of traded portfolios and portfolios publicly disclosing their holdings, when the said portfolios are tailored to a specific retirement year or specific customer risk level, and there is neither method nor system to recommend to a customer a consensus asset allocation derived from the said portfolios.

Portfolio Analysis Module: Background Art

The background arts are given in the Reference section and are incorporated here by reference.

There is extensive patent and other literature describing systems either to analyze risk of an existing portfolio, or to predict returns of an existing portfolio, or to create an optimized portfolio, or to manage trades of an existing portfolio.

Nevertheless, to the best of authors' knowledge, there is neither apparatus nor system to automatically analyze a customer's existing portfolio to determine whether the said existing investment portfolio is appropriate for the said customer, and to suggest changes and improvements to the said existing investment portfolio.

Popular Securities Module: Background Art

The prior art is given in the References section and are incorporated here by reference.

There is substantial prior art dealing with online presentation of a news digest aggregating all information related either to a particular investment opportunity (for example, a publicly traded stock) or selecting several opportunities most frequently discussed in the media sources.

Nevertheless, when all news about, for example, a particular stock are aggregated from several media sources in a digest, an investor or a customer of the said digest is overwhelmed with clutter, since many news about frequent routine announcements, like earnings reports or stock price movements, are mixed with the less frequent news about the in-depth discussions of the said stock fundamentals and future prospects. Moreover, the existing systems present information from all media sources, thus mixing news from trustworthy popular sources with the news from tiny online publications without any established history or proven record.

To the best of authors' knowledge, there is neither method, nor system, no apparatus to present compact, consolidated and relevant digest or snapshot of investment opportunities fundamentally discussed in the popular trusted media sources, so customers like investors and financial advisers would be able to quickly review such compact information in one place saving their time and efforts.

Valuation Discovery Module: Background Art

The background arts are given in the Reference section and are incorporated here by reference.

There is extensive patent and other art describing systems and databases either to store historical financial data of corporate actions and events affecting prices of all securities, or of historical and upcoming index rebalances affecting publicly traded portfolios, or services to help an individual fund or portfolio to recover funds stemming from a corporate action or securities litigation.

Nevertheless, to the best of authors' knowledge, there is neither apparatus, nor system, nor method, nor database to automatically determine how historical and future financial events and corporate actions will affect or had affected in the past the prices and net asset values of publicly traded funds and portfolios. There is also neither apparatus, nor system, nor database to automatically determine how historical and future events in a publicly traded portfolio or fund had affected or will affect prices of securities composing the said publicly traded portfolio or fund, or how the said events had affected or will affect prices of securities being included into the said publicly traded portfolio or fund in the future, or how the said events had affected or will affect prices of other publicly traded portfolios or funds.

Construction of Portfolio Module: Background Art

The references are given in the Reference section and are incorporated here by reference.

There is extensive patent and other literature describing construction of an investment portfolio based on asset allocation for a given customer.

Nevertheless, to the best of authors' knowledge, there is neither system, nor method, nor apparatus to construct an investment portfolio for a customer based on popular securities, and to suggest changes to an existing portfolio of the said customer to align it with the said constructed investment portfolio.

The said popular securities can be selected in many different ways, not necessarily by the implementation of the Popular Securities Module described in this patent application. By the way of a non-limiting example, the said popular securities can be the securities with the largest average trading volumes. Other examples are given in the description of the module below.

Asset Allocation Module: Description

The invention relates generally to money management, portfolio construction, retirement planning, and financial consulting, and more specifically to a system and method of determining consensus asset allocation from established portfolios publicly disclosing their holdings, when the said portfolios are designed for a specific retirement year, or for a specific investor risk level, or both for a specific retirement year and for a specific risk level of their investors.

Preferred embodiments are described to illustrate the present invention, not to limit its scope, which is defined by the important features.

Those of ordinary skill in the art will recognize a variety of equivalent variations on the description that follows.

Step A.01: A customer enters on a web page his or her basic demographical and financial information including, by the way of non-limiting example, her birth date, her anticipated retirement age, her total assets, her family status, and her anticipated financial obligations, and the said customer submits these data over Internet.

The said customer can select whether to submit or not to submit any personally identifiable information to address privacy concerns and to comply with privacy protection laws and regulations.

The said web page to enter customer data, by the way of non-limiting example, can be implemented in a PHP or ASP preprocessor language and converted to an HTML page on the hosting web server.

A JavaScript application on the web page dynamically checks customer entered data and prompts a customer to correct invalid data, as if, by the way of a non-limiting example, a customer enters her birthday before the year 1890.

The said webpage transmits the customer data to a relational database. The customer data is stored in the said database for further processing.

Step A.02: A computer application calculates the said customer's self-anticipated retirement age and risk level based on the customer data transmitted to the said database. The said computer application can be implemented in several computer languages, like SQL, PLPGSQL, MySQL, C++, and others

A non-limiting example of how to adjust customer risk level is given later.

Step A.03: Current asset allocation of several publicly available mutual funds, exchange-traded portfolios, unit investment trusts, and similar financial instruments is stored in a database, along with each fund's stated target retirement year and risk level. A computer application written for example in MySQL or SQL selects the funds stating in their prospectuses retirement years close to the customer retirement year, as well as the funds stating in their prospectuses risk profiles similar to the customer risk profile.

Step A.04: A consensus asset allocation for the said customer is recommended based on weighted average allocation of the selected funds to each asset. The said consensus asset allocation is calculated by the said computer application in the said relational database. The said calculation is totally automated.

The said calculated consensus asset allocation is displayed to the said customer via an HTML web page generated on the hosting server by a script implemented in PHP or ASP preprocessor language.

The said PHP or ASP script calls a stored database procedure to recommend consensus asset allocation based on customer data and publicly available asset allocation information form the step A.03 above.

By the way of a non-limiting example, let's assume the said customer plans to retire in 2034, and the risk profile of the said customer is moderate or average, so no adjustments to the retirement year are necessary.

Let's also assume that at this moment the publicly available mutual funds are only targeting retirement years 2030 and 2035. It is an industry standard to offer retirement years of mutual funds in five year increments, so it is very reasonable to expect no mutual funds would be targeting said customer retirement year 2034.

Let us assume, for the sake of simplicity and by the way of a non-limiting example, that there are three mutual funds stating in their prospectuses the retirement year 2030 and three mutual funds stating the retirement year 2035, the said funds being A2030, B2030, C2030, A2035, B2035, and C2035, respectively.

For the sake of simplicity, let us consider only a few asset classes, US Large Market Capitalization Growth stocks (USLCG), US Large Market Capitalization Value stocks (USLCV), US Small Market Capitalization stocks (USSC), Emerging Market Stocks (EM), and US Aggregate Bonds (USB), and let's assume the allocation to these asset classes is given in the Exhibit A.01 below.

Let's denote these average allocation weights across our selected mutual funds marked Average 2030 and Average 2035 in the Exhibit A.01 as Consensus Weights 2030 and 2035, respectively.

Then for the said customer retiring in 2034 the computer application would calculate weighted average consensus weights as, for example, a straight line approximation using the following formula

(Consensus weight 2034)=[(Consensus weight 2035)−(Consensus weight 2030)]*(2034−2030)/(2035−2030)+(Consensus weight 2030).

In our example, the last formula yields Consensus Weights 2034 shown in the Exhibit A.02.

Those of ordinary skill in the art will recognize a variety of equivalent variations to transform a Consensus Asset Allocation into a recommended asset allocation for the said customer in addition to the method suggested in the Exhibit A.02. For example, the recommended asset allocation for the said customer retiring in 2034 can be obtained by simply selecting consensus weights of the nearest retirement year available for mutual funds, in our example 2035. As another example, an average of the consensus weights for the two nearest available retirement years, 2030 and 2035, can be a recommended asset allocation for the said customer retiring in 2034.
Adjusting customer retirement year based on the said customer's risk profile

The consensus asset allocation recommended in Step A.04 of the description above can be further adjusted based on customer risk profile.

For example, if the said customer as in our example above plans to retire in 2034, but the said customer indicates on the web page that she has relatively limited financial resources, about $200,000, and a large family of three very young children and herself as a single parent, then the computer application determines the said customer to be conservative, i.e. risk averse, and recommends to allocate the said customer's assets based on a retirement year adjusted to a more conservative, earlier retirement year of 2031.

On the other hand, if the said customer as in our example above plans to retire in 2034, but the said customer indicates on the web page that she has relatively large financial resources, about $3,000,000 and a small family of her independently wealthy husband who would totally support their only one teenager child, then the computer determines the said customer to be aggressive, i.e. allowing more risk, and recommends to allocate the said customer's assets based on a retirement year adjusted to a more aggressive, later retirement year of 2037.

Exhibit A.04: A Non-Limiting Example of Web Screenshot: Asset Allocation Customer Questionnaire

Asset Allocation Questionnaire

This questionnaire is completely anonymous. The investor does not have to provide any of his contact information to receive a recommended asset allocation.*See FIG. 22

The following disclosure may be added to the form:

Disclosure: If you later decide to select some of the products recommended by our website, or to interact with our partners, some your additional personal information may be required to perform such transactions.

You would be explicitly asked for additional information if such information is necessary to accomplish any of your transactions.
You would be able to decide whether to provide any such information or not.

Portfolio Analysis Module: Description

The invention relates generally to money management, portfolio construction, retirement planning, and financial consulting, and more specifically to analyzing and improving of the customer current existing portfolio.

Preferred embodiments are described to illustrate the present invention, not to limit its scope, which is defined by the important features.

Those of ordinary skill in the art will recognize a variety of equivalent variations on the description that follows.

Step B.01a: A customer enters on a website his or her current existing investment portfolio including, by the way of a non-limiting example, the names and other identifying information of the publicly-traded and private, domestic and foreign securities like stocks, mutual funds, closed-end funds, hedge funds, UIT, CTA, commodity pools, corporate and government bonds, bills, notes, bank certificates of deposit, money market funds, etc.

The said customer has a choice to indicate tax information related to each investment position.

Alternatively, a customer can enter for analysis only a specific subset of her or his investment portfolio like, by the way of non-limiting example, all her investments in publicly-traded equities, or all her investments in fixed-income products, or all her investments in closed-end funds.

The customer also indicates either the number of units of each security in her portfolio, or the current value of each security, or the percent of each security in the said analyzed portfolio.

The said customer can select whether to submit or not to submit any personally identifiable information to address privacy concerns and to comply with privacy protection laws and regulations.

The said website to enter customer portfolio data, by the way of a non-limiting example, can be implemented in a PHP or ASP preprocessor language and converted to an HTML page on the hosting web server.

A JavaScript application on the said website dynamically checks customer entered data and prompts the said customer to correct invalid data, as if, by the way of a non-limiting example, the said customer erroneously enters her investment in IBM stock as “International Bu$y Machines” instead of “International Business Machines Corp”. The said script verifies that only permitted characters are entered as the stock tickers, and that only digits, currency signs, points and commas are entered as the investment amounts.

The said website transmits the customer portfolio data to the host server and then to a relational database.

The customer portfolio data is stored in the said database for further processing.

Step B.01b [alternative instead of Step B.01a]: A customer indicates on the website her or his permission to a one-time electronic download of her or his investments from one or more accounts of the said customer. The said customer accounts can be held at one or more financial institutions providing secure electronic connectivity, like custodians, brokerages, banks, mutual funds, financial advisors, insurance companies, etc.

The said customer enters her or his identifying login information for the said financial institutions, like user names and passwords. Alternatively, the said customer contacts her or his financial institutions and gives her or his permission to the said website for a limited accounts access, just to view and download the account positions without any ability to trade, withdraw funds, or make any changes to the said customer account.

The said website securely connects to the financial institution websites via https protocol employing the highest encryption possible, and the said website downloads customer investment positions to a relational database.

To address security and privacy, all customer-identifying login information for the said financial institutions is deleted after the required usage and not stored.

Only the customer portfolio data is stored in the said relational database for further processing.

Step B.02: On the same or on a separate webpage within the same website, the said customer also enters her or his investment goals, objectives, and style or answers a few questions to broadly define her investment objectives. By the way of a non-limiting example, the goals can include in how many years the said customer plans to retire or to rely on the said portfolio as his or her major source of income.

The objectives can include whether the said customer can tolerate large losses in the portfolio, what size of losses she can afford, whether she wants to restrict her investment choices based on her religious, environmental, or social values, and what her tax situation is.

The style can include how often the said customer trades securities in her portfolio, how often she adds new securities, how often she reduces, increases, or eliminates her existing positions in securities, and how often she rebalances her portfolio.

Step B.03: A computer application maintains and updates data on the majority (or all) of currently available securities and their investment parameters in another relational database. By the way of a non-limiting example, the investment parameters include asset class, asset category, asset subcategory, and further parameters relevant to each asset class or category.

By the way of a non-limiting example, the stored IBM common stock parameters would indicate equity as asset class, US common stock as asset category, large market capitalization as market cap relevant to equities, information technology as sector, diversified computer system as industry, etc. Other parameters for the said IBM common stock can include the number of shares outstanding, average daily volume to assess its liquidity, average bid-ask spread to assess implied cost of trading, etc.

Alternatively, an IBM bond would include among its parameters its maturity date, coupon amount, coupon frequency, its investment grade, whether the bond is callable or put-able and, if yes, the call or put schedule, other bond options, current bond duration, current yield to maturity, current yield to call, average bid-ask spread to assess implied cost of trading, and similar bond parameters.

The mutual fund parameters would include asset class of the fund, its style, its rating, its fees and expenses, its front end sales load, its minimal initial and subsequent investment, its total assets, its latest holdings, and its average historical returns. The unit investment trust (UIT) parameters, in addition to the mutual fund parameters mentioned above, would also include open enrollment period, expiration date, available secondary markets, and related UIT's for roll-over.

Step B.04: The portfolio securities entered by the said customer are matched to the securities maintained in the said relational database. If no match can be found for some securities, a webpage application written in PHP or ASP script language prompts the said customer to correct such non-matched securities or to enter additional information about such non-matched securities.

Step B.05. A computer application written in SQL, C#, or similar languages utilizes data in the said relational databases and determines how the said customer portfolio is appropriate for the said customer's explicitly or implicitly stated investment goals, objectives, and style, and how optimal the said customer portfolio is from the point of view of modern portfolio theory. In addition, this computer application estimates whether the said customer portfolio can be improved, and suggests improvements to make the portfolio performance more appropriate for the said customer.

Step B.06. A computer application maintains and updates a third relational database. The said database contains the list of all asset classes, asset categories, asset subcategories, sectors, industries, etc. Each of the said asset classes or asset subcategories the said relational database is matched to one or more publicly-traded securities approximating the said asset class or asset subcategory. By the way on a non-limiting example, for the asset category “Japanese equities” the said relational database matches iShares MSCI Japan Exchange Traded Fund EWJ, and for the asset category “US Small Cap” the said relational database matches iShares Russell 2000 Index Fund IWM. The said relational database is used to suggest as additions to the said customer existing investment portfolio some securities broadly following specific asset classes, categories, sectors, or industries, given that a specific asset class, category, sector, or industry is missing or underrepresented in the said customer existing investment portfolio.

Step B.07. A webpage offers the said customer links to financial institutions to implement the recommended changes to the said customer current investment portfolio.

By the way of a non-limiting example, let's assume the said customer plans to retire in 2034, wants to limit her investment choices to socially responsible investing as defined by Domini Social Index®, can afford up to 50% loss in her portfolio, and trades about 1.0% of the assets in her portfolio every month.

Let's also assume that the said customer portfolio is entered as in the Exhibit B.01. Schematic implementation of the portfolio analysis module and the portfolio analysis engine are given in the Exhibits B.05 and B.06, respectively.

Exhibit B.02: An Example of a Customer Recommendation Displayed on the said Website

Your Planned Retirement year: 2034

Your stock portfolio would be a major source of your retirement income.

Your Portfolio Turnover: 1% monthly.

We Estimated Your Trading Costs: $899 per annum assuming 0.25% cost of each trade

Your Trading Costs are acceptable, below average.

You desire socially responsible investment as defined by Domini Social Index®

Asset Allocation Your Current Stock Portfolio is 100% US Large Cap.

Concentration:

Your portfolio is OVER-concentrated in Information Technology Sector.

IBM, MSFT12012C00030000, HPQ, and DIA have exposure to Information Technology Sector.

Multiple Exposures

3 of your stock holdings: IBM, MSFT12012C00030000, and HPQ are also components of the Exchange-Traded Portfolio DIA.

Score of your portfolio: 33% appropriate for your investment profile.

Recommendations:
We recommend reducing your US Large Cap exposure to 47% of your portfolio and diversifying into US Mid Cap, US Small Cap, International Stocks and Emerging Market.
We recommend reducing your Information Technology Sector exposure to 56% of your portfolio and diversifying into other Sectors, following socially responsible guidelines of Domini Social Index®.

Our recommended diversification would reduce volatility and limit possible losses in your portfolio.

Our recommended diversification would enhance your expected returns.

Options and Derivatives:

1. MSFT12012C00030000 Microsoft Corp January 2012 Call Option $1,845,123

Your portfolio contains HIGH level of options for your loss tolerance.

Stress Test:

More than 90% of your $1,845,123 options and derivatives investment can be lost if the market moves by 20%.
We recommend reducing your options and derivatives exposure to 25% or less of your portfolio

Such diversification would reduce volatility and limit possible losses in your portfolio.

You choose not to include your tax and estate information, so no recommendations are given on your portfolio tax efficiency.

Exhibit B.04. Suggested additions to the customer current stock portfolio

Our recommended diversification would reduce volatility and limit possible losses in your portfolio.

Our recommended diversification would enhance your expected returns.

The additions suggested to your portfolio below are one of many ways to follow the asset categories missing or underrepresented in your portfolio.

Popular Securities Module: Description

The invention relates generally to financial publishing, financial news presentation, financial consulting, portfolio construction, and money management, and more specifically to presenting a consolidating view or digest of investment opportunities discussed in media sources.

Preferred embodiments are described to illustrate the present invention, not to limit its scope, which is defined by the features.

Those of ordinary skill in the art will recognize a variety of equivalent variations on the description that follows.

C.1. An internet connected computer application frequently scouts a pre-selected set of popular media publications to find recently published predictions, forecasts, and discussion that can be transformed into investment opportunities. By the way of a non-limiting example, the said discussion of investment opportunities can recommend buying or selling publicly or privately traded securities, including common stocks, bonds, mutual funds, closed-end funds, commodities, exchange traded funds, unit investment trusts (UIT), money market funds, bank certificates of deposit, bills, notes, etc.

C.2. Even when a published forecast or prediction does not explicitly identify an investable security to profit from the said published forecast, the said computer application uses a pre-determined set of keywords matching investment opportunities. By the way of a non-limiting example, when a published article predicts a drastic change in the oil, silver, or gold prices in the near future, the said article is matched to an investment opportunity in one of the exchange traded funds backed by oil, silver or gold, respectively.

C.3. The said computer application initially filters the news items containing in-depth discussions from the news items containing routine announcements by looking only in specific sections of the said pre-selected set of popular media publications. The said specific sections are usually devoted to in-depth discussions of investment opportunities. A relational database maintained on the host server contains a list of online addresses of the said specific sections of the pre-selected set of popular media publications. The said relational database also contains separate logic for filtering the materials inside each section of each of the popular media publications, including, for example, the minimal length of a news item in characters and words, the place of the webpage where the news items with in-depth discussions of investment opportunities usually appear, a list of the authors of the said news items with in-depth discussions of investment opportunities, etc. Therefore, the said computer application significantly narrows the number of the news items of interest.

C.4. The said computer application frequently presents the list of the investment opportunities that it finds along with the text of the articles to a website editor. The said editor is a human employee quickly approving or rejecting the said published investment opportunities for inclusion in the digest published on a website. The said computer application allows a very efficient use of the said editor's time, since instead of reading hundreds of articles, the said editor has just to scan throw a couple of dozen articles.

C.5. Some simple investment opportunities do not require the said editor's approval and their inclusion in the website digest can be totally automated. For example, each of the popular media sources usually follows its specific format week-after-week or day-after-day to recommend buying or selling publicly traded common stocks. Therefore, composing a news digest of the said articles for investment opportunities can be fully automated. A human editor is required when, for example, a published article predicts dropping silver prices and discusses the economic fundamentals supporting or contradicting such prediction. The said human editor has to decide whether the wording of the article is strong enough to interpret it as a recommendation to sell or short-sell securities that are to follow the price of silver. Similarly, if the said computer application cannot decide whether the recommendation is to buy or to sell because several keywords are matched, the said human editor is alerted to make a decision.

C.6. The said computer application can be implemented on the host server with internet connection in any of the numerous programming languages, for example, C#, PHP, or ASP. Parsing of the content of the articles can be implemented in any of the programming languages with PERL style regular expressions. It can be simpler to implement all the modules of the said computer application in the same programming language, or it can be beneficial to implement the word-parsing module of the said computer application in PERL.

C.7. The get-content module of the said computer application periodically connects to pre-selected parts of the websites of popular media publications and downloads to a temporarily database all recent articles that can be matched investment opportunities by the process described above.

C.8. The word-parsing module of the said computer application parses the articles from the said temporarily database, and determines whether or not each news item can be included in the digest without involvement of the said human editor.

C.9. The said word processing module publishes in the digest links and references to the news items which it can confidently identify as fundamental discussions of investment opportunities. The said word processing module presents to a human editor for review the news items where the said computer module cannot make a decision about inclusion of the said news items in the digest.

C.10. After the said digest is published, a computer program searches the web for all publications [web blogs] discussing the same security and indicates the total number of web blogs to inform the customers of the popularity of each security.

C.11. The said computer program also lets customers to vote whether they would buy or sell each security and presents the aggregated result of the said customer vote for customer information.

Valuation Discovery Module: Description

The invention relates generally to reporting of financial data, money management, and securities trading, and more specifically to a database, system, and method of determining either effects of events in securities held in a publicly traded portfolio at any time on the price of the said publicly traded portfolio, or the effects of events in a publicly traded portfolio on the prices of securities composing the said publicly traded portfolio, the effects of events in a publicly traded portfolio on the prices of securities that are known being included into the said publicly traded portfolio in the future, or the prices of other publicly traded portfolios or funds.

Preferred embodiments are described to illustrate the present invention, not to limit its scope, which is defined by the important features.

Those of ordinary skill in the art will recognize a variety of equivalent variations on the description that follows.

Step AA.01: A relational database DB01 periodically downloads from the Internet or from one or more data vendors the current and historical disclosed holdings of all major portfolios and funds currently or historically available for public investment. The said holdings include the names and identifications of all securities held in the said publicly traded portfolio at a specific date and time, the said date and time of the composition, and the time of the said disclosure. Maintenance of the said relational database can be implemented in several programming languages, like SQL, PLPGSQL, MySQL, C#, and others. The said major portfolios or funds publicly disclosing their holdings can be, by the way of a non-limiting example, open-end mutual funds, closed end funds, exchange traded funds, exchange traded notes, unit investment trusts (UIT), HOLDERS, publicly traded investment management companies, investment clubs publicly disclosing their holdings, and similar securities.

Step AA.02: Another relational database DB02 periodically downloads from the Internet or from one or more data vendors the current and historical publicly disclosed financial events and corporate actions affecting substantially any securities that either are currently publicly tradable or were publicly tradable in the past. By the way of a non-limiting example, the said events include awards to former shareholders of a security in a litigation settlement, pending litigation declared inclusion or exclusion of a security from a major index, declared tender offers for a security, etc.

Step AA.03: Yet another relational database DB03 periodically downloads from the Internet or from one or more data vendors the current and historical publicly disclosed financial events and corporate actions affecting substantially any publicly tradable portfolios or portfolios that were publicly tradable in the past. By the way of a non-limiting example, the said events include fines and penalties imposed by a regulator on a fund sponsor, or a court order mandating change of control of a fund family sponsor.

Step AA.04 A customer via a webpage based application creates a computer search query defining her area of interest on corporate events or actions by selecting several predefined parameters.

By the way of a non-limiting example, the said parameters include the time frame of events, the timeframe of event impacts, the category of the affected portfolios like ETF, UIT, open-end mutual funds, etc, the range of the total net assets of the affected portfolios, the estimated size of the impact, a specific security, etc.

The said parameters can be selected from a drop-down menu or entered into text-boxes on the said web-page.

By the way of the second non-limiting example, the said customer can indicate her interest in the events in the next six months affecting publicly traded ETFs.

By the way of the third non-limiting example, the said customer can indicate her interest in the events in the next twelve months in Unit Investment Trusts (UIT) with total net assets more than $100M.

By the way of the fourth non-limiting example, the said customer can leave all the parameters blank, and then the said website will download all historical and future events affecting any prices.

By the way of a non-limiting example, the said webpage to enter a customer search query can be implemented in a PHP or ASP preprocessor language and converted to an HTML page on the hosting web server.

A JavaScript application on the said website dynamically checks customer entered data and prompts the said customer to correct invalid data, as if, by the way of a non-limiting example, the said customer erroneously enters her interest in IBM stock as “International Bu$y Machines” instead of “International Business Machines Corp”. The said script verifies that only valid dates are entered, that only permitted characters are entered as the stock tickers, and that only digits, currency signs, points and commas are entered as the amounts.

The said computer application makes suggestions of securities to the said customer based on the few letter in the security name entered by the said customer.

The said suggestions and corrections can be accepted or rejected by the said customer.

The said website transmits the customer search query data to the host server via Internet and then to a relational database.

The customer search query is stored in the said database for further processing.

Step AA.05 A computer program implemented in either SQL, or PLPGSQL, or MySQL, or C#, or a similar programming language generates a computer query matching events in the database DB02 from the Step A.02, or in the database DB03 from the Step A.03 to affected publicly tradable major portfolios or funds currently or historically available for public investment in the database DB01 from the Step A.01. The said query is limited to the parameters of interest indicated by the said customer in the step A.04. The said computer program further sorts the output of the said query per customer specifications and limits the size of the output according to the preferences of the said customer.

Construction of Portfolio Module: Description

The invention relates generally to money management, portfolio construction, retirement planning, and financial consulting, and more specifically to automatically constructing customer's portfolio based on the criteria described further, comparing the said constructed portfolio with the existing customer's portfolio, and automatically suggesting changes to the said existing customer's portfolio to better align it with the said constructed customer's portfolio.

Preferred embodiments are described to illustrate the present invention, not to limit its scope, which is defined by the important features.

Those of ordinary skill in the art will recognize a variety of equivalent variations on the description that follows.

Step D.01. The website contains a webpage to determine the customer's investment profile where a customer answers basic questions about his or her financial situation and investment goals.

Step D.02. The said website's asset allocation module determines an asset allocation most appropriate for the said customer. The said asset allocation module can be either the asset allocation module described in this invention or a different asset allocation module.

Step D.03. The said website popular securities module displays a web page presenting to its customers a list of most popular securities, i.e., the most popular investment opportunities for different asset classes. The said popular securities module can be either the popular securities module described in this invention or a different asset allocation module.

By the way of the first non-limiting example, the said most popular investment opportunities can be selected as the securities with the largest trading parameters. The said trade parameters can be either the average daily trading volume, or the total assets invested in a security, or market capitalization available for trading, or the ratio of the mid price to bid-ask spread, etc.

By the way of the second non-limiting example, the said most popular investment opportunities can be selected as the securities most widely discussed ether in popular trusted media sources or in all media sources.

By the way of the third non-limiting example, the said most popular investment opportunities can be selected as the securities rated by consensus of trusted investment publications to have the highest appreciation potential.

Step D.04. The said website presents the said customer with alternative, non-popular, but index-like securities replicating specific asset classes or categories for which popular securities are not available at the moment. By the way of a non-limiting example, if the said most popular investment opportunities are selected as the securities most widely discussed in popular trusted media sources, and the said popular trusted media sources have not discussed during the last few months any specific long term US corporate bonds, then the said system presents the said customer with an ETN (exchange traded note) or ETF (exchange traded fund) tracking the broad index of the said long term US corporate bonds and indicates to the said customer the reason for absence of popular securities in the said asset category of long term US corporate bonds.

Step D.05. The said website allows the said customer to back-test the performance of the said constructed investment portfolio for a specified number of years. By the way of a non-limiting example, the said website can show an interactive chart displaying historical cumulative total returns of the said constructed investment portfolio during the previous ten years and compare it to the broad market benchmarks, like S&P 500 index or aggregated US bond index

Step D.06. The said website also contains a webpage to determine and analyze the existing portfolio of the said customer. The said portfolio analysis module can be the module described in this invention or a totally different portfolio analysis module. If the said customer does not want or cannot enter his or her existing portfolio, the said website assumes the said customer has no existing portfolio and just constructs a new investment portfolio.

Step D.07. The said website suggests changes to the said customer's existing portfolio to better align it with the said constructed investment portfolio.

Step D.08. The said website provides the said customer with the links to one or more financial institutions to implement the suggested changes to the said customer existing portfolio. If the said customer does not want or cannot enter his or her existing portfolio, the said website provides the said customer with the links to one or more financial institutions able to implement the said constructed investment portfolio for the said customer.

The apparatus may be implemented on a standalone device such as a desk top, laptop, tablet, or smart phone utilizing software or an appropriate app. Alternatively the invention may be implemented as a website.

Obviously numerous modifications may be made to this invention without departing from its scope as defined in the appended claims.

We claim:

1. An apparatus generating financial information comprising:
an input receiving investor information from an inventor;
a portal to external financial and other external information;
several modules receiving said investor and said external information and operating on said information to generate proposed financial strategies to an investor and
an output module generating at least one financial strategy to the investor.
